(19) United States
(12) Patent Application Publication
(10) Pub. No.: US 2025/0104680 A1
(43) Pub. Date: Mar. 27, 2025

(54) DISPLAY CONTROL DEVICE, DISPLAY DEVICE, METHOD, AND STORAGE MEDIUM

(71) Applicant: CASIO COMPUTER CO., LTD., Tokyo (JP)

(72) Inventors: Yumi AIHARA, Tokyo (JP); Shingo OKANO, Tokyo (JP); Tomoya KAJIKAWA, Tokyo (JP); Osamu MORIYAMA, Tokyo (JP)

(21) Appl. No.: 18/891,943

(22) Filed: Sep. 20, 2024

(30) Foreign Application Priority Data
Sep. 21, 2023 (JP) 2023-154096
Sep. 19, 2024 (JP) 2024-162297

(51) Int. Cl. G10H 1/40; G10H 1/34

(52) U.S. Cl. CPC G10H 1/40; G10H 1/34; G10H 2210/076; G10H 2220/086

(57) ABSTRACT

A display control device includes: a memory that stores a program; and at least one processor that executes the program stored in the memory, wherein the processor: controls a light source unit, sets one tempo from among a plurality of tempos, and changes a display form of light emitted from the light source unit and projected on a display section from a third display form to a first display form according to a first beat timing of the set tempo, a first period in which the light is projected while being changed between the third display form and the first display form has a constant length regardless of the set tempo, and the constant length is a length of less than one beat of a fastest tempo among settable tempos.

### CROSS-REFERENCE TO RELATED APPLICATIONS

This application claims priority based on Japanese Patent Applications Nos. 2023-154096 filed in Japan on Sep. 21, 2023 and 2024-162297 filed in Japan on Sep. 19, 2024, the entire contents of which are incorporated herein.

### FIELD

The present disclosure relates to a display control device, a display device, a method, and a storage medium.

### BACKGROUND

There is known an electronic metronome that visually shows a beat or a tempo to a user by using light. A specific configuration of this type of electron metronome is described in, for example, WO 2005/93529 A.

The electronic metronome described in WO 2005/93529 A includes an array in which a plurality of light emitting elements are arranged in a vertical column. The electronic metronome imitates movement of a baton by sequentially switching a light emitting element to be turned on and moving light in a longitudinal direction.

### SUMMARY

A display control device according to the present disclosure includes: a memory that stores a program; and at least one processor that executes the program stored in the memory. The processor sets one tempo from among a plurality of tempos, and changes a display form of light emitted from the light source unit and projected on a display section from a third display form to a first display form according to a first beat timing of the set tempo. A first period in which the light is projected while being changed between the third display form and the first display form has a constant length regardless of the set tempo. The constant length is a length of less than one beat of a fastest tempo among settable tempos.

According to the present disclosure, it is possible to provide a display control device, a display device, a method, and a storage medium that allow a user to easily grasp a beat timing.

### BRIEF DESCRIPTION OF THE DRAWINGS

FIG. 1 is an overall perspective view of an electronic musical instrument according to an embodiment of the present disclosure;

FIG. 2 is a partial perspective view of the electronic musical instrument according to an embodiment of the present disclosure;

FIG. 3 is a block diagram illustrating a configuration of the electronic musical instrument according to an embodiment of the present disclosure;

FIG. 4 is an exploded perspective view of a display unit included in the electronic musical instrument according to an embodiment of the present disclosure;

FIG. 5 is an explanatory diagram in a case where the display unit operates as an electronic metronome in an embodiment of the present disclosure;

FIG. 6 is an explanatory diagram in a case where the display unit operates as the electronic metronome in an embodiment of the present disclosure;

FIG. 7 is a diagram illustrating a relationship between a display form of light projected on a display section and a time in an embodiment of the present disclosure;

FIG. 8 is a diagram for describing a length by which the light projected on the display section pulsates on a time axis in an embodiment of the present disclosure;

FIG. 9A is a flowchart illustrating metronome processing executed by a sub processor included in the electronic musical instrument according to an embodiment of the present disclosure; and

FIG. 9B is a flowchart illustrating the metronome processing executed by the sub processor included in the electronic musical instrument according to an embodiment of the present disclosure.

### DETAILED DESCRIPTION

In the electronic metronome according to the related art exemplified in WO 2005/93529 A, for example, it is difficult to recognize a beat timing depending on a tempo. Such an electronic metronome (an example of a display device) has room for improvement from the viewpoint of making it easy for the user to grasp the beat timing. In contract, the present disclosure can support so as to allow a user to easily grasp a beat timing.

A display control device, a display device, and a method and a program executed by the display device that is an example of a computer according to an embodiment of the present invention will be described in detail with reference to the drawings.

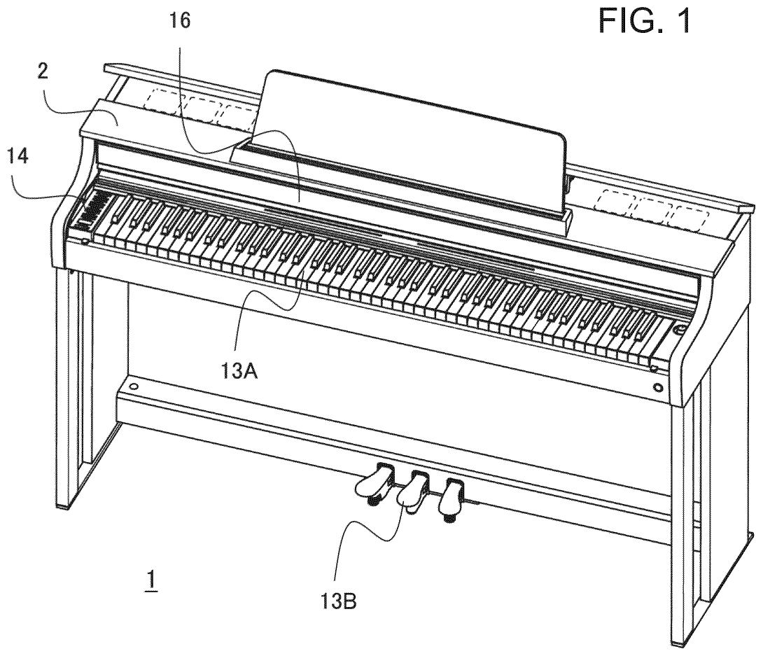

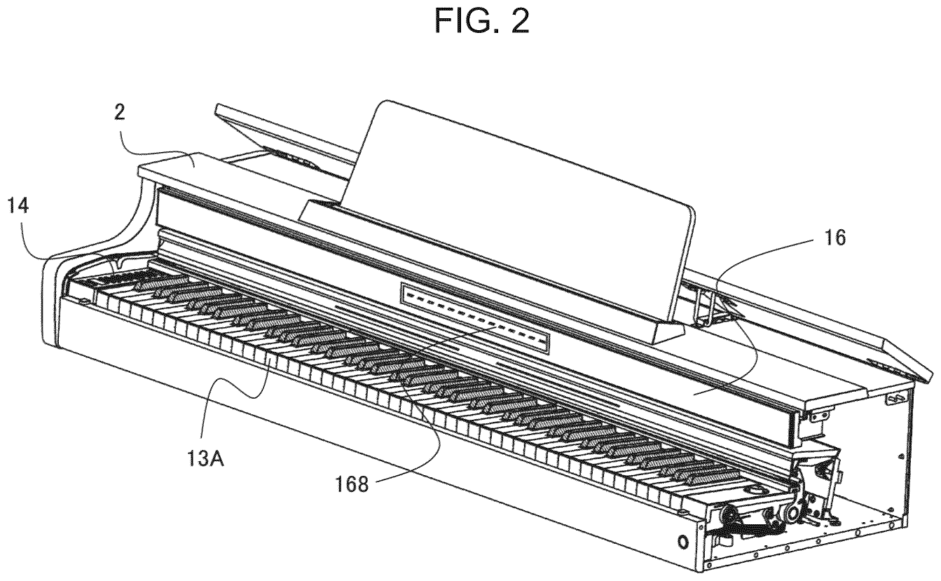

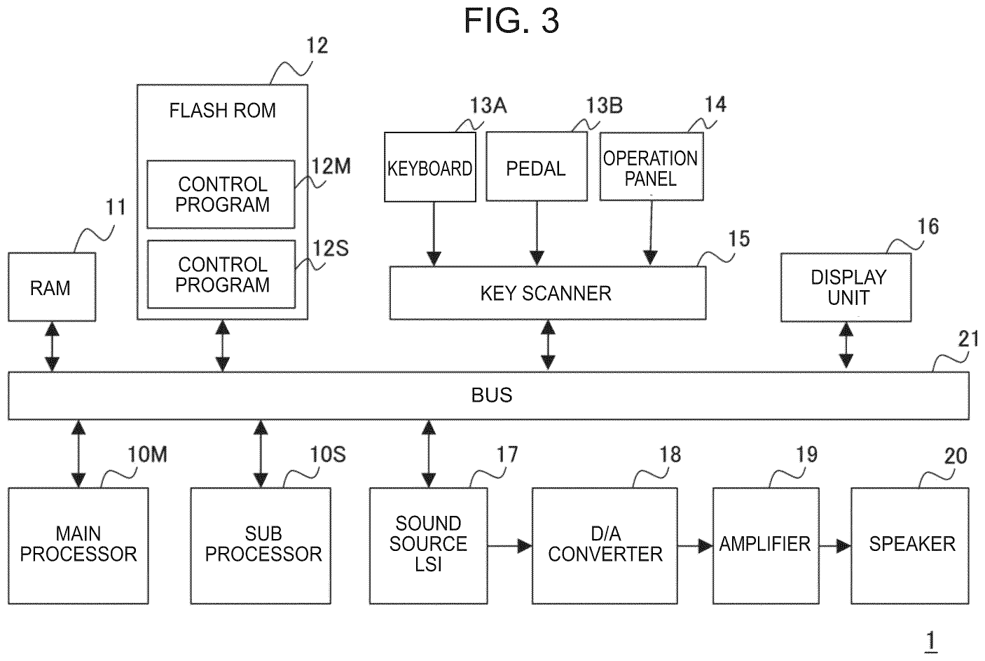

FIG. 1 is an overall perspective view of an electronic musical instrument 1 according to an embodiment of the present invention. FIG. 2 is a partial perspective view of the electronic musical instrument 1. FIG. 3 is a block diagram illustrating a configuration of the electronic musical instrument 1.

The electronic musical instrument 1 is an example of a display device including a display control device, and is, for example, an electronic piano.

The display control device according to the present embodiment includes a controller that controls a light source unit. The controller sets one tempo from among a plurality of tempos, and changes a display form of light emitted from the light source unit and projected on a display section from a third display form to a first display form according to a first beat timing of the set tempo. A first period during which the light is projected while being changed between the third display form and the first display form has a constant length regardless of the set tempo. The constant length is a length of less than one beat of the fastest tempo among settable tempos.

That is, a display device according to the present embodiment operates as an electronic metronome that visually shows a beat and a tempo to a user by using light. In the display device according to the present embodiment, the first period in which the light is projected while being changed between the third display form and the first display form has a length of less than one beat of the fastest tempo regardless of the set tempo. Since the light has a display form in which the light is projected only for a short time according to a beat timing, there is no ambiguity in the beat timing, and as a result, the beat timing is emphasized. Therefore, the user can easily grasp the beat timing.

The electronic musical instrument 1 may be an electronic keyboard instrument other than an electronic piano, such as an electronic keyboard. The electronic musical instrument 1 may be another form of electronic musical instrument such as an electronic percussion instrument, an electronic wind instrument, or an electronic string instrument.

As illustrated in FIGS. 1 and 2, the electronic musical instrument 1 includes a housing 2. The housing 2 supports a keyboard 13A, a pedal 13B, an operation panel 14, and a display unit 16.

As illustrated in FIG. 3, the electronic musical instrument 1 includes a main processor 10M, a sub processor 10S, a random access memory (RAM) 11, a flash read only memory (ROM) 12, the keyboard 13A, the pedal 13B, the operation panel 14, a key scanner 15, the display unit 16, a sound source large scale integration (LSI) 17, a D/A converter 18, an amplifier 19, and a speaker 20. Each unit of the electronic musical instrument 1 is connected by a bus 21.

Each of the main processor 10M and the sub processor 10S reads a program and data stored in the flash ROM 12, respectively. The main processor 10M and the sub processor 10S control the electronic musical instrument 1 by using the RAM 11 as a work area.

Each of the main processor 10M and the sub processor 10S is, for example, a single processor or a multiprocessor, and includes at least one processor. In the case of a configuration including a plurality of processors, each of the main processor 10M and the sub processor 10S may be packaged as a single device, or may be configured by a plurality of devices physically separated in the electronic musical instrument 1. The main processor 10M and the sub processor 10S may be referred to as, for example, a controller, a central processing unit (CPU), a micro processor unit (MPU), or a micro controller unit (MCU).

The main processor 10M and the sub processor 10S may be a single processor instead of separate processors.

The RAM 11 temporarily holds data and a program. The RAM 11 holds various programs and various data such as waveform data read from the flash ROM 12.

The flash ROM 12 is a nonvolatile semiconductor memory such as a flash memory, an erasable programmable ROM (EPROM), or an electrically erasable programmable ROM (EEPROM). The flash ROM 12 stores, for example, control programs 12M and 12S. The main processor 10M and the sub processor 10S execute the control programs 12M and 12S, respectively, so that various types of processing according to an embodiment of the present invention are executed.

The keyboard 13A includes a plurality of white keys and a plurality of black keys. Each key is associated with a different pitch. The electronic musical instrument 1 produces a musical sound according to a key pressing operation on a key included in the keyboard 13A.

The pedal 13B includes three pedals which are performance operation elements. Specifically, the pedal 13B includes a damper pedal, a soft pedal, and a sostenuto pedal. When the user performs the key pressing operation on a key while stepping on a pedal, the electronic musical instrument 1 performs sound production processing by adding an acoustic effect associated with the pedal being stepped on to the musical sound.

The operation panel 14 includes various operation units such as a power switch and a metronome function setting switch.

The key scanner 15 monitors key pressing and key release on the keyboard 13A. For example, when detecting a key pressing operation performed by the user, the key scanner 15 outputs a key pressing event to the main processor 10M. The key pressing event includes information (key number) regarding a pitch of a key related to the key pressing operation. The key number may also be referred to as a number of a key, a musical instrument digital interface (MIDI) key, or a note number.

In the present embodiment, means for measuring a key pressing velocity is separately provided, and the velocity measured by the means is also included in the key pressing event. Exemplarily, a plurality of contact switches are provided for each key. The velocity is measured by a difference in time during which each contact switch is conducted when the key is pressed. The velocity can be said to be a value indicating a strength of the key pressing operation or a value indicating a loudness (volume) of the musical sound.

The display unit 16 operates as the electronic metronome that visually shows a beat or tempo to the user by using light. The display unit 16 will be specifically described below.

The waveform data is stored in the flash ROM 12 or another memory (not illustrated). The waveform data is loaded into the RAM 11 at the time of activation processing for the electronic musical instrument 1 so that a musical sound is promptly produced in response to a key pressing operation. When the key scanner 15 detects a key pressing operation, the main processor 10M instructs the sound source LSI 17 to read the corresponding waveform data from the waveform data loaded in the RAM 11. The waveform data to be read is determined according to, for example, a tone selected by a user operation and the key pressing event.

The sound source LSI 17 generates a musical sound based on the waveform data read from the RAM 11 under an instruction of the main processor 10M. The sound source LSI 17 includes, for example, 128 generator sections, and can simultaneously produce up to 128 musical sounds. In the present embodiment, the main processor 10M, the sub processor 10S, and the sound source LSI 17 are configured as separate processors, but in another embodiment, the main processor 10M, the sub processor 10S, and the sound source LSI 17 may be configured as one or two processors.

Digital musical sound data generated by the sound source LSI 17 is converted into an analog signal by the D/A converter 18, then amplified by the amplifier 19, and output to the speaker 20.

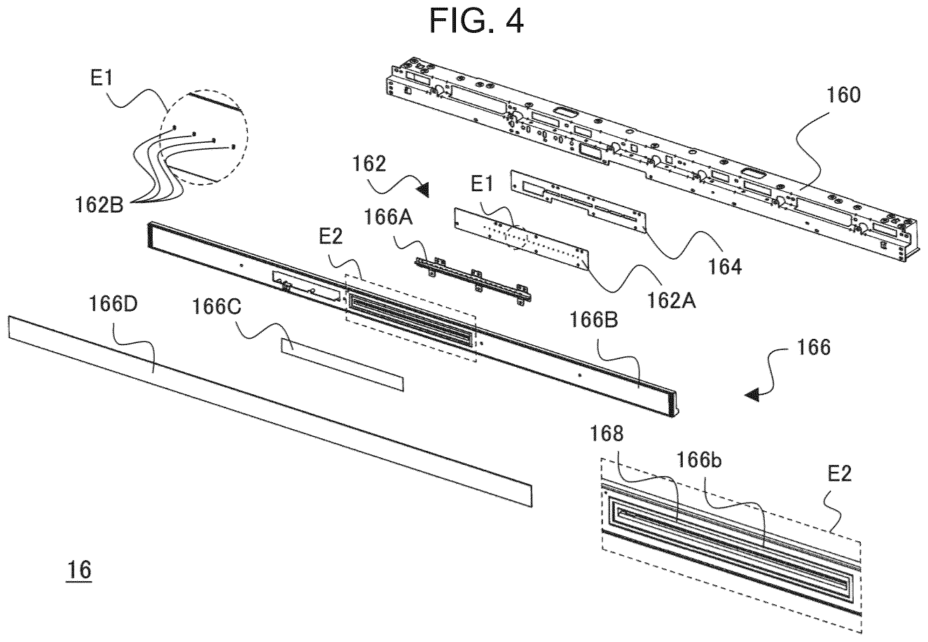

FIG. 4 is an exploded perspective view of the display unit 16. As illustrated in FIG. 4, the display unit 16 includes a sheet metal member 160, a light source unit 162, an insulating sheet 164, and a display section 166.

The sheet metal member 160 is supported inside the housing 2. Each part of the display unit 16 is supported by the housing 2 via the sheet metal member 160.

The light source unit 162 includes a light emitting diode (LED) substrate 162A and LEDs 162B.

The LED substrate 162A is a rectangular substrate. The plurality of LEDs (an example of light emitting elements) 162B are attached to the LED substrate 162A. In the present embodiment, 20 LEDs 162B are arranged in a row at equal intervals in a longitudinal direction (for convenience, referred to as a “left-right direction”) of the LED substrate 162A. The LED 162B is, for example, a white LED that emits pseudo white light.

The insulating sheet 164 is a rectangular sheet member having a shape corresponding to the LED substrate 162A and a size slightly larger than that of the LED substrate 162A, and has an insulating property. The insulating sheet 164 is sandwiched between the sheet metal member 160 and the LED substrate 162A to prevent a short circuit between the sheet metal member 160 and the LED substrate 162A.

The display section 166 includes a light guide member 166A, a light shielding case 166B, a diffusion sheet 166C, and an acrylic panel 166D.

The light guide member 166A is made of, for example, polycarbonate or acryl having translucency. The light guide member 166A is assembled to the light shielding case 166B. The light guide member 166A is positioned in front of each LED 162B in a state of being assembled to the light shielding case 166B. The light guide member 166A guides light emitted from the LED 162B forward.

The light shielding case 166B is made of black polystyrene, for example, and has a light shielding property. The light shielding case 166B is formed in a rectangular shape elongated in the left-right direction. An emission opening 166b is formed substantially at the center of the light shielding case 166B. The emission opening 166b has a rectangular shape elongated in the left-right direction.

The light emitted from the LED 162B is projected on the display section 166. That is, the display section 166 shows the light emitted from the light source unit 162.

Specifically, most of the light emitted from the LED 162B is incident on the light guide member 166A. A part of the light incident on the light guide member 166A travels substantially straight inside the light guide member 166A and is emitted from the light guide member 166A.

An emission surface of the light guide member 166A is textured. Therefore, light reaching the emission surface of the light guide member 166A is irregularly reflected by the textured emission surface, and is emitted from the emission surface with high efficiency.

The diffusion sheet 166C is made of, for example, polyethylene terephthalate (PET), and has a light diffusing property. The light emitted from the light guide member 166A is diffused by the diffusion sheet 166C, and is emitted from the light shielding case 166B forward from the emission opening 166b with a substantially uniform luminance.

The acrylic panel 166D is attached to a front surface of the light shielding case 166B. Light diffused by the diffusion sheet 166C and emitted from the light shielding case 166B is emitted to the outside through the acrylic panel 166D.

The light emitted from the light guide member 166A is blocked by the light shielding case 166B at a portion other than the emission opening 166b. That is, only a rectangular region elongated in the left-right direction and defined by the emission opening 166b is a display region (hereinafter, denoted by reference sign 168) in which the light can be projected. Hereinafter, the light projected in the display region 168 is referred to as “light L”.

The display region 168 (in other words, the emission opening 166b) is positioned in front of the 20 LEDs 162B arranged in a row in the left-right direction. In FIG. 2, the LED 162B is illustrated for convenience of clearly indicating a positional relationship between the display region 168 and each LED 162B. The LED 162B is positioned behind the acrylic panel 166D, the diffusion sheet 166C, and the light guide member 166A. Therefore, the LEDs 162B are substantially invisible in appearance.

Specifically, each part of the display section 166 is housed in the housing 2, and the acrylic panel 166D has a flat exterior surface as illustrated in FIG. 1. In addition, external light hardly reaches the inside of the housing 2 due to the light shielding case 166B positioned on a back side of the acrylic panel 166D. Therefore, it is difficult for the user to visually recognize each part in the housing 2.

That is, the user cannot visually recognize a position of the LED 162B even when viewing a portion where the LED 162B is disposed. Therefore, the user cannot grasp a range in which the light L is projected when the LED 162B is in a turned-off state.

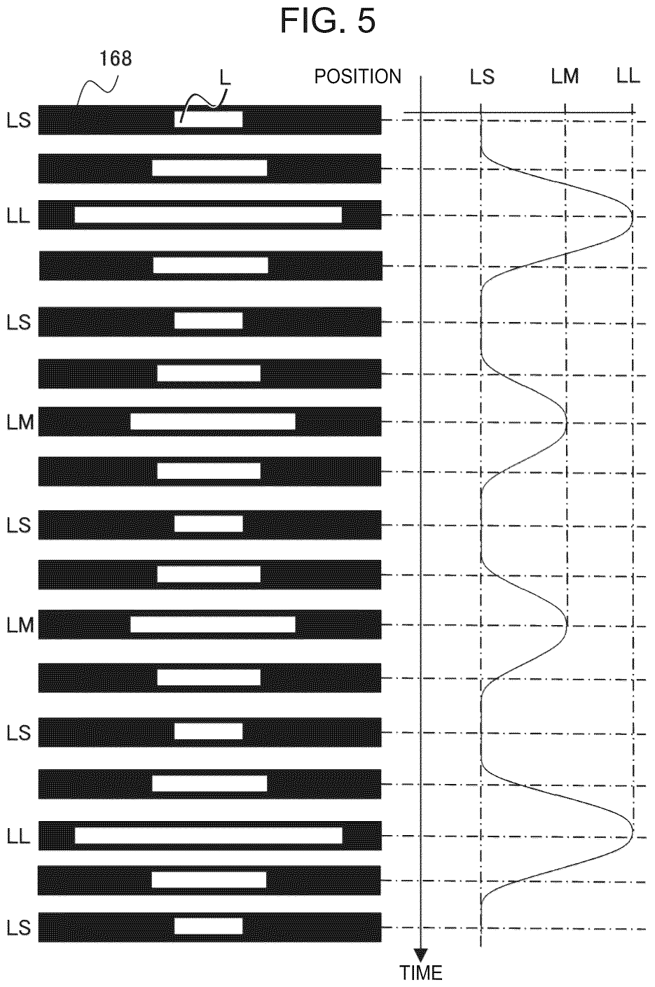

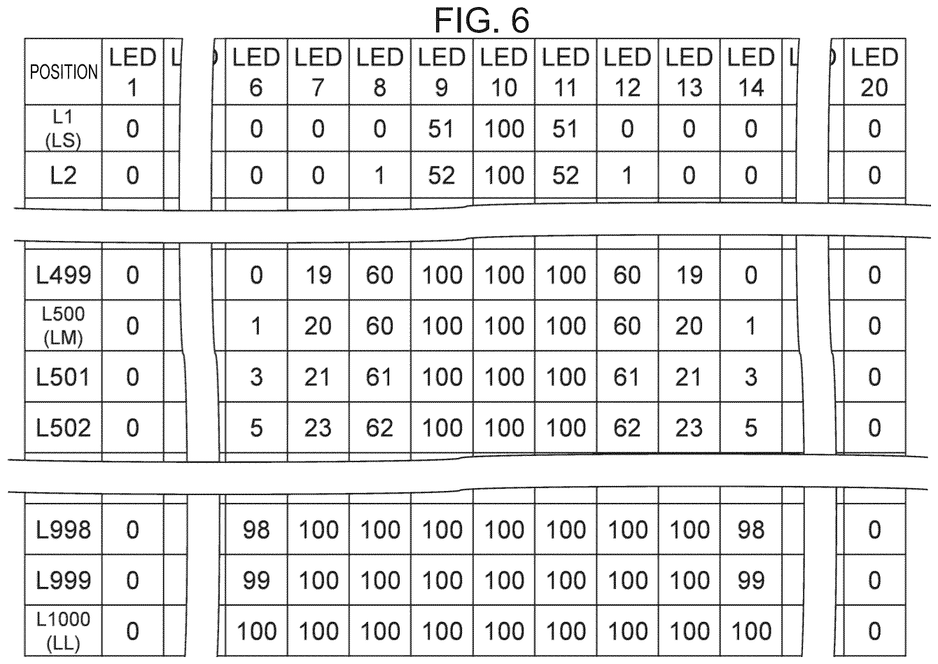

FIGS. 5 and 6 are explanatory diagrams in a case where the display unit 16 operates as the electronic metronome.

FIG. 5 illustrates a change of a display form of the light L projected in the display region 168 on a time axis. In FIG. 5, the left drawing illustrates a state in which the light L expresses triple time in the display region 168. In FIG. 5, the graph on the right side corresponds to the left drawing and shows a relationship between the display form of the light L and time.

As illustrated in FIG. 5, a width (a length in the left-right direction) of the light L is changed such that the light L pulsates according to a beat. In FIG. 5, sign LS indicates an initial width of the light L. Reference sign LM indicates a width of the light L at a weak beat timing. Reference sign LL indicates a width of the light L at a strong beat timing. Hereinafter, the initial width of the light L is referred to as an “initial width LS”. The width of the light L at the weak beat timing is referred to as a “weak beat width LM”. The width of the light L at the strong beat timing is referred to as a “strong beat width LL”.

In the present embodiment, a “strong beat” refers to the first beat of n (n is a natural number) beats, and a “weak beat” refers to each of the second to n-th beats. For example, in the case of 4/4 time, the first beat is the strong beat, and the second to fourth beats are the weak beats. In addition, all the second and subsequent beats do not have to be the weak beats. At least one weak beat included in the second and subsequent beats may be replaced with a medium strong beat that is stronger than the weak beat and weaker than the strong beat.

Light with the strong beat width LL is an example of light of the first display form having a first width, and expresses the storing beat. Light with the weak beat width LM is an example of light of a second display form having a second width, and expresses the weak beat. Light with the initial width LS is an example of light of the third display form having a third width.

The weak beat width LM is larger than the initial width LS. The strong beat width LL is larger than the weak beat width LM. As for a ratio of the widths, when the initial width LS is 1, for example, the weak beat width LM is 4, and the strong beat width LL is 10.

The strong beat timing is an example of the first beat timing. The weak beat timing is an example of a second beat timing.

The light L expands and contracts according to the beat timing with the initial width LS as the minimum width. The light L expands to the weak beat width LM at the weak beat timing. The light L expands to the strong beat width LL at the strong beat timing.

That is, as illustrated in FIG. 5, the light L instantaneously expands from the initial width LS to the strong beat width LL according to the strong beat timing, and returns to the initial width LS again. Next, the light L instantaneously expands from the initial width LS to the weak beat width LM according to the weak beat timing, and returns to the initial width LS again. The light L further instantaneously expands from the initial width LS to the weak beat width LM according to the weak beat timing, and returns to the initial width LS again. In this manner, the light L expands and contracts in a pulsating manner according to the strong beat, the weak beat, and the weak beat, so that the light L expresses triple time.

FIG. 6 is a diagram illustrating a relationship between each display form of the light L and a lighting pattern of the LEDs 162B. In FIG. 6, the leftmost LED 162B among the 20 LEDs 162B is indicated as “LED 1”. A higher number is assigned to the LED 162B further to the right. Therefore, the rightmost LED 162B among the 20 LEDs 162B is indicated as “LED 20”. In FIG. 6, a numerical value (0 to 100) indicates a luminance of the LED 162B. The luminance of 0 indicates a state in which the LED 162B is not turned on. The luminance of 100 indicates a state in which the LED 162B is turned on with the highest luminance.

Light emission of the LEDs 162B is controlled by the sub processor 10S. As illustrated in FIG. 6, the sub processor 10S controls light emission of the light L with 1000 lighting patterns corresponding to widths L1 to L1000.

The larger the numerical values (L1 to L1000) of the reference signs, the larger the width of the light L in the left-right direction. Hereinafter, reference signs LP1 to LP1000 denote the lighting patterns corresponding to the widths L1 to L1000, respectively. The width L1 (lighting pattern LP1), the width L500 (lighting pattern LP500), and the width L1000 (lighting pattern LP1000) are the initial width LS, the weak beat width LM, and the strong beat width LL, respectively.

The sub processor 10S appropriately switches the lighting pattern of the LEDs 162B to perform the light emission control of the 20 LEDS 162B. That is, the sub processor 10S operates as the controller that controls the display form (here, the width) of the light L on the display section 166 by controlling the light source unit 162.

For example, the sub processor 10S turns on LEDs 9 to 11 with luminances of 51, 100, and 51, respectively, and does not turn on LEDs 1 to 8 and LEDs 12 to 20. That is, when the sub processor 10S performs light emission control with the lighting pattern LP1, the light L is projected at the position P1 as light having the initial width LS at the central portion in the display region 168.

Next, the sub processor 10S gradually increases the luminances of the LEDs positioned on the left and right of LED 10 by an extremely small amount. When the sub processor 10S sequentially performs the light emission control with the lighting pattern LP2 and the subsequent lighting patterns, the width of the light L gradually and smoothly is increased.

By individually and gradually changing the luminances of the plurality of LEDs 162B, a gradual increase in width of the light L can be smoothly expressed.

When the strong beat timing is near, the sub processor 10S sequentially switches the lighting pattern from the lighting pattern LP1 to the lighting pattern LP1000 at a high speed, and instantaneously expands the light L from the initial width LS to the strong beat width LL. When the light L expands to the strong beat width LL at the strong beat timing, the sub processor 10S sequentially switches the lighting pattern from the lighting pattern LP1000 to the lighting pattern LP1 at a high speed to instantaneously return the light L from the strong beat width LL to the initial width LS. As a result, as illustrated in FIG. 5, the light L is displayed in a form of greatly pulsating so as to express the strong beat.

When the weak beat timing is near, the sub processor 10S sequentially switches the lighting pattern from the lighting pattern LP1 to the lighting pattern LP500 at a high speed, and instantaneously expands the light L from the initial width LS to the weak beat width LM. When the light L expands to the weak beat width LM at the weak beat timing, the sub processor 10S sequentially switches the lighting pattern from the lighting pattern LP500 to the lighting pattern LP1 at a high speed to instantaneously return the light L from the weak beat width LM to the initial width LS. As a result, as illustrated in FIG. 5, the light L is displayed in a form of slightly pulsating so as to express the weak beat.

In this manner, the sub processor 10S continuously changes the width of the light L such that the light L pulsates according to the beat timing.

The 20 LEDs 162B (an example of a plurality of light emitting elements) are arranged on a straight line corresponding to a width direction of the light L.

In the present embodiment, a large number (1000) of display forms (widths) are sequentially switched at a high speed. Since a resolution of the adjustable width is high and the switching of the width is fast, the width of the light L appears to smoothly expand and contract in the display region 168.

An operation of the display unit 16 as the electronic metronome will be described in more detail.

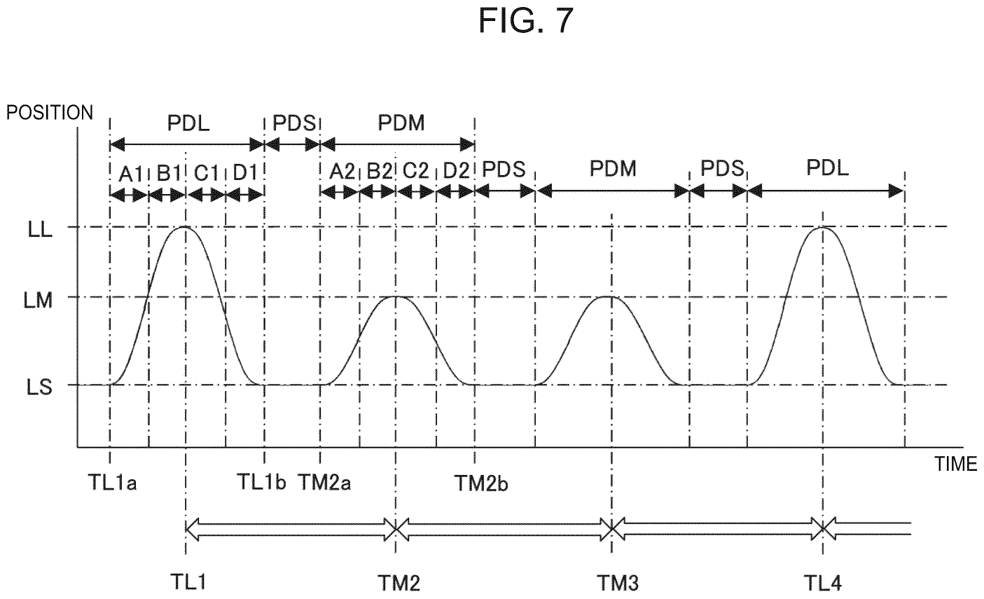

FIG. 7 is a diagram illustrating a relationship between the display form (width) of the light L and time. In FIG. 7, reference signs TL1 and TL4 indicate the strong beat timings. Reference signs TM2 and TM3 indicate the weak beat timings. In the example of FIG. 7, triple time in which the strong beat, the weak beat, and the weak beat are repeated is illustrated. Each period (a period from the strong beat timing TL1 to the weak beat timing TM2, a period from the weak beat timing TM2 to the weak beat timing TM3, and a period from the weak beat timing TM3 to the strong beat timing TL4) indicated by a bidirectional arrow has the same length and corresponds to the length of one beat.

A period PDL is an example of the first period, and indicates a period in which the light L is projected while being changed between the initial width LS and the strong beat width LL in the display region 168. A period PDM is an example of a second period, and indicates a period in which the light L is projected while being changed between the initial width LS and the weak beat width LM in the display region 168. The period PDS is an example of a third period, and indicates a period in which the light L maintains the initial width LS.

In addition, the period PDL is a period from a first time point (for example, a time point TL1a) before the strong beat timing to a second time point (for example, a time point TL1b) after the strong beat timing. The period PDM is a period from a third time point (for example, a time point TL2a) before the weak beat timing to a fourth time point (for example, a time point TL2b) after the weak beat timing. The period PDS is a period between the period PDL (or the period PDM) and the period PDM.

As illustrated in FIG. 7, the width of the light L increases for a moment so as to greatly pulsate during the first period PDL. The light L maintains the initial width LS during the next period PDS, and then is changed in width so as to slightly pulsate during the subsequent period PDM. The light L further maintains the initial width LS during the next period PDS, and then is changed in width so as to slightly pulsate again. While an electronic metronome function is turned on, the light L expresses triple time by repeating such a pulsating operation.

More specifically, in the period PDL (an example of the first time point, for example, the time point TL1a), the light L expands from the initial width LS to the strong beat width LL before the strong beat timing (for example, the timing TL1), and returns from the strong beat width LL to the initial width LS during a period from the strong beat timing to an end point of the period PDL (an example of the second time point, for example, the time point TL1b). That is, the light L expands for a moment to the strong beat width LL expressing the storing beat at the strong beat timing.

In the period PDM (an example of the third time point, for example, the time point TM2a), the light L expands from the initial width LS to the weak beat width LM before the weak beat timing (for example, the timing TM2), and returns from the weak beat width LM to the initial width LS during a period from the weak beat timing to an end point of the period PDM (an example of the fourth time point, for example, the time point TM2b). That is, the light L expands for a moment to the weak beat width LM expressing the weak beat at the weak beat timing.

For example, when the light L slowly expands and contracts over time, the beat timing becomes ambiguous. In addition, when the expansion and contraction are slowly reproduced with a smooth expression such as pulsation (that is, when the light L slowly and smoothly expands and contracts), the beat timing becomes further ambiguous. Therefore, in the present embodiment, the display form of the light L is changed such that the light L pulsates in a short time.

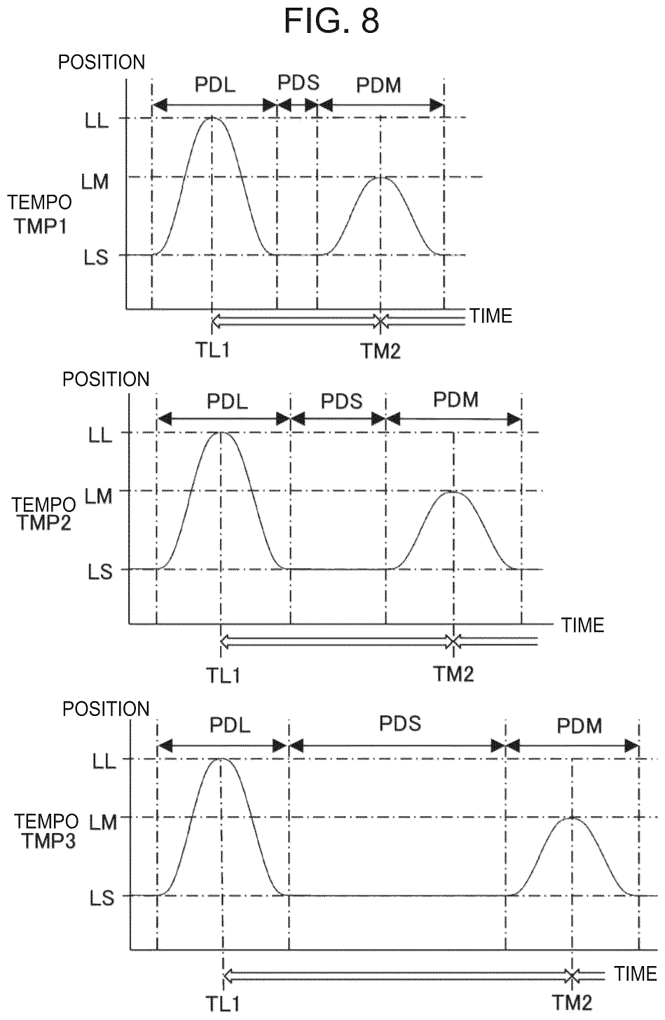

FIG. 8 is a diagram illustrating a length by which the light L pulsates on a time axis. Similarly to the example of FIG. 7, each period (the period from the strong beat timing TL1 to the weak beat timing TM2 and a period between the respective beat timings after the weak beat timing TM2 (not illustrated)) indicated by the bidirectional arrow has the same length and corresponds to the length of one beat.

The user can set a tempo of the electronic metronome by operating the operation panel 14. The upper drawing, the middle drawing, and the lower drawing in FIG. 8 illustrate a relationship between the display form (width) of the light L and time when the set tempo is a tempo TMP1, TMP2, or TMP3. Among the tempos TMP1 to TMP3, the tempo TMP1 is the fastest tempo and the tempo TMP3 is the slowest tempo. The tempo TMP2 is a tempo slower than the tempo TMP3 and faster than the tempo TMP1.

As illustrated in FIG. 8, the period PDL and the period PDM have constant lengths regardless of the set tempo. The lengths of the period PDL and the period PDM are lengths of less than one beat of the fastest tempo among settable tempos.

For example, the sub processor 10S sets one tempo from among tempos 20 to 255 according to a user operation. In this case, the lengths of the period PDL and the period PDM are n % (for example, 20% or 40%) of a time taken for one beat of the tempo 255.

In this manner, the light L pulsates only during a period less than one beat of the fastest tempo. Since the light L is projected in the display region 168 so as to pulsate for a short time according to the beat timing, there is no ambiguity in the beat timing, and as a result, the beat timing is emphasized. Therefore, the user can easily grasp the beat timing.

The faster the tempo, the shorter the fixed time (that is, the period PDS corresponding to the initial width LS) of the light L. The slower the tempo, the longer the fixed time of the light L.

The period PDS in which the light L does not move is a period between the period PDL in which the light L greatly pulsates and the period PDM in which the light L slightly pulsates. By visually recognizing that the light L does not move during the period PDS, the user can intuitively grasp that a period between beats is reached. By grasping the period in which there is no beat, the user can easily grasp the beat timing in the period PDL and the period PDM.

A time (for example, a time from the time point TL1a to the timing TL1) from the first time point to the strong beat timing, a time (for example, a time from the timing TL1 to the time point TL1b) from the strong beat timing to the second time point, a time (for example, a time from the time point TM2a to the timing TM2) from the third time point to the weak beat timing, and a time (for example, a time from the timing TM2 to the time point TM2b) from the weak beat timing to the fourth time point have the same length or substantially the same length. By making pulsation times of the light L before and after the beat timing have the same length or substantially the same length, the user can more intuitively grasp the beat timing.

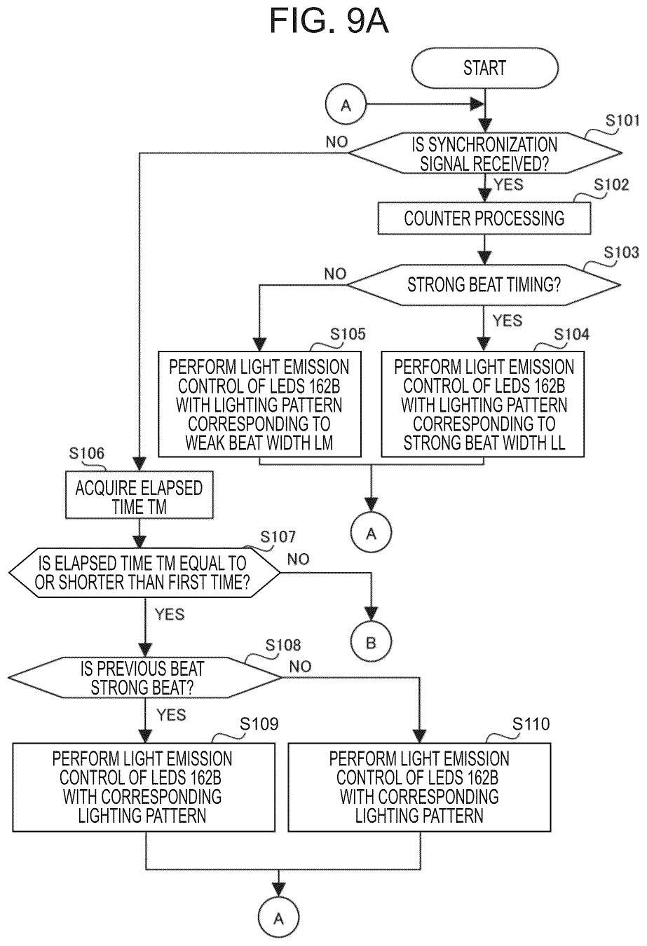

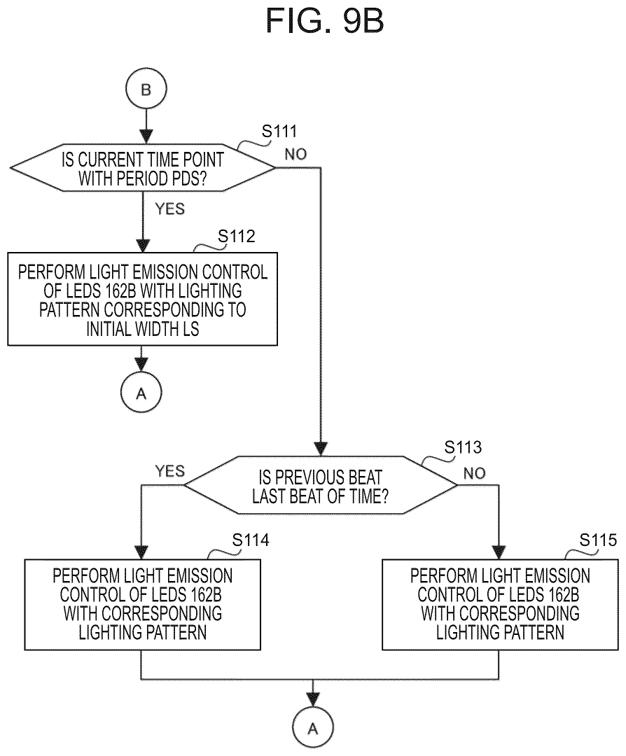

FIGS. 9A and 9B are flowcharts illustrating metronome processing executed by the sub processor 10S in an embodiment of the present invention. For example, when a user operation of turning on the electronic metronome function is performed on the operation panel 14, execution of the metronome processing is started.

When the electronic metronome function is turned on, the main processor 10M transmits a synchronization signal to the sub processor 10S at a timing corresponding to the set tempo (in other words, every time the beat timing comes), and at the same time, causes the speaker 20 to output a sound for notifying of a beat.

The set tempo is a tempo set by a user operation performed on the operation panel 14. In a case where the user operation is not performed, the set tempo is an initially determined tempo.

As illustrated in FIG. 9, the sub processor 10S waits for the synchronization signal from the main processor 10M (step S101).

In a case where the synchronization signal is received from the main processor 10M (step S101: YES), the sub processor 10S resets a count value of a built-in counter and starts counting at the same time (step S102).

Strictly speaking, the beat timing (such as TL1 or TM2) illustrated in FIGS. 7 and 8 is a timing at which the sub processor 10S receives the synchronization signal. A synchronization signal reception timing may be appropriately adjusted in consideration of a signal delay in the sub processor 10S.

The sub processor 10S determines whether or not the strong beat timing is reached (step S103).

In the case of the strong beat timing (step S103: YES), the sub processor 10S performs the light emission control of the LEDs 162B with the lighting pattern LP1000 corresponding to the strong beat width LL (step S104), and returns to the processing of step S101.

In the case of the weak beat timing (step S103: NO), the sub processor 10S performs the light emission control of the LEDs 162B with the lighting pattern LP500 corresponding to the weak beat width LM (step S105), and returns to the processing of step S101.

In a case where the synchronization signal is not received from the main processor 10M (step S101: NO), the sub processor 10S acquires an elapsed time TM (in other words, the count value of the built-in counter) from the last reception of the synchronization signal (step S106).

The sub processor 10S determines whether or not the elapsed time TM acquired in step S106 is equal to or shorter than a first time (step S107). The first time is, for example, the half the period PDL (period PDM).

In a case where the elapsed time TM is equal to or shorter than the first time (step S107: YES), only a short time has elapsed from the previous beat timing. The sub processor 10S determines whether or not the previous beat is the strong beat (step S108).

In a case where the previous beat is the strong beat (step S108: YES), the sub processor 10S performs the light emission control of the LEDs 162B corresponding to the strong beat with the lighting pattern corresponding to the elapsed time TM based on information stored in the flash ROM 12 (step S109), and returns to the processing of step S101. The lighting pattern corresponding to the elapsed time TM in a case where the previous beat is the strong beat is stored in the flash ROM 12.

In a case where the previous beat is the weak beat (step S108: NO), the sub processor 10S performs the light emission control of the LEDs 162B corresponding to the weak beat with the lighting pattern corresponding to the elapsed time TM based on information stored in the flash ROM 12 (step S110), and returns to the processing of step S101. The lighting pattern corresponding to the elapsed time TM in a case where the previous beat is the weak beat is stored in the flash ROM 12.

In a case where the elapsed time TM exceeds the first time (step S107: NO), the sub processor 10S determines whether or not the current time point is within the period PDS (step S111).

In a case where the current time point is within the period PDS (step S111: YES), the sub processor 10S performs the light emission control of the LEDs 162B with the lighting pattern LP1 corresponding to the initial width LS (step S112), and returns to the processing of step S101.

In a case where the current time point is outside the period PDS (that is, in a case where the period PDS has passed and the next beat timing is near) (step S111: NO), the sub processor 10S determines whether or not the previous beat is the last beat of time (step S113). For example, in the case of triple time, the second weak beat after the strong beat is the last beat of the time. For example, in the case of 4/4 time, the third weak beat after the strong beat is the last beat of the time.

In a case where the previous beat is the last beat of the time (step S113: YES), the next beat is the first beat (that is, the strong beat) of the next time. Therefore, the sub processor 10S performs the light emission control of the LEDs 162B corresponding to the strong beat with the lighting pattern corresponding to the elapsed time TM based on information stored in the flash ROM 12 (step S114), and returns to the processing of step S101.

In a case where the previous beat is not the last beat of the time (step S113: NO), the next beat is the next weak beat of the same time. Therefore, the sub processor 10S performs the light emission control of the LEDs 162B corresponding to the weak beat with the lighting pattern corresponding to the elapsed time TM based on information stored in the flash ROM 12 (step S115), and returns to the processing of step S101.

The sub processor 10S repeatedly executes the metronome processing illustrated in FIGS. 9A and 9B, for example, until the electronic metronome function is turned off. In other words, when the electronic metronome function is turned off, the sub processor 10S ends the execution of the metronome processing.

By the execution of the metronome processing illustrated in FIG. 9, the pulsation of the light L according to the beat timing appears in the display region 168 for a short time. As a result, there is no ambiguity in the beat timing, and as a result, the beat timing is emphasized. Therefore, the user can easily grasp the beat timing.

The light L starts pulsing slightly before the beat timing. By visually recognizing the start of the pulsation of the light L, the user can grasp in advance that the beat timing is about to arrive. Also from this point, the user can more easily grasp the beat timing.

In addition, the present invention is not limited to the above-described embodiments, and various modifications can be made in the implementation stage without departing from the gist thereof. Furthermore, the functions executed in the above-described embodiments may be appropriately combined and implemented as much as possible. The above-described embodiments include various stages, and various inventions can be extracted by appropriate combinations of a plurality of disclosed constituent elements. For example, even if some components are deleted from all the components shown in the embodiment, if an effect can be obtained, a configuration from which the components are deleted can be extracted as an invention.

Any reference to elements using designations such as “first”, “second”, and the like as used in the present disclosure does not generally limit the amount or order of those elements. These designations may be used in the present disclosure as a convenient way to distinguish between two or more elements. Therefore, reference to the first and second elements does not mean that only two elements may be employed or that the first element must precede the second element in any way.

What is claimed is:

1. A display control device comprising:
a memory that stores a program; and
at least one processor that executes the program stored in the memory, wherein
the processor:
controls a light source unit,
sets one tempo from among a plurality of tempos, and
changes a display form of light emitted from the light source unit and projected on a display section from a third display form to a first display form according to a first beat timing of the set tempo,
a first period in which the light is projected while being changed between the third display form and the first display form has a constant length regardless of the set tempo, and
the constant length is a length of less than one beat of a fastest tempo among settable tempos.

2. The display control device according to claim 1, wherein
the processor changes the display form of the light from the third display form to a second display form according to a second beat timing of the set tempo, and
a second period in which the light is projected while being changed between the third display form and the second display form has the constant length regardless of the set tempo.

3. The display control device according to claim 2, wherein
the processor:
changes the display form of the light to the first display form expressing a strong beat at the first beat timing during the first period, and
changes the display form of the light to the second display form expressing a weak beat at the second beat timing during the second period.

4. The display control device according to claim 3, wherein
the light having the first display form is light having a first width, and
the light having the second display form is light having a second width smaller than the first width.

5. The display control device according to claim 4, wherein
the processor causes the light having the third display form in which the light has a third width smaller than the first width and the second width to be projected on the display section during a third period other than the first and second periods.

6. The display control device according to claim 2, wherein
the first period is a period from a first time point before the first beat timing to a second time point after the first beat timing, and
the second period is a period from a third time point before the second beat timing to a fourth time point after the second beat timing.

7. The display control device according to claim 6, wherein
the processor:
expands the light having the third display form in which the light has a third width to the light having the first display form in which the light has a larger width during a period from the first time point to the first beat timing, and contracts the light having the first display form to the light having the third display form during a period from the first beat timing to the second time point, and
expands the light having the third display form to the light having the second display form in which the light has a width larger than that of the light having the third display form and smaller than that of the light having the first display form during a period from the third time point to the second beat timing, and contracts the light having the second display form to the light having the third display form during a period from the second beat timing to the fourth time point.

8. A display device comprising:
the display control device according to claim 1;
the light source unit; and
the display section on which the light emitted from the light source unit is projected.

9. A method executed by a computer including a processor that controls a light source unit, the method comprising:
setting one tempo from among a plurality of tempos; and
changing a display form of light emitted from the light source unit and projected on a display section from a third display form to a first display form according to a first beat timing of the set tempo, wherein
a first period in which the light is projected while being changed between the third display form and the first display form has a constant length regardless of the set tempo, and
the constant length is a length of less than one beat of a fastest tempo among settable tempos.

10. The method according to claim 9, wherein
the display form of the light is changed from the third display form to a second display form according to a second beat timing of the set tempo, and
a second period in which the light is projected while being changed between the third display form and the second display form has the constant length regardless of the set tempo.

11. The method according to claim 10, further comprising:
changing the display form of the light to the first display form expressing a strong beat at the first beat timing during the first period; and
changing the display form of the light to the second display form expressing a weak beat at the second beat timing during the second period, wherein
the light having the first display form is light having a first width, and
the light having the second display form is light having a second width smaller than the first width.

12. The method according to claim 11, further comprising causing the light having the third display form in which the light has a third width smaller than the first width and the second width to be projected on the display section during a third period other than the first and second periods.

13. The method according to claim 10, wherein
the first period is a period from a first time point before the first beat timing to a second time point after the first beat timing, and
the second period is a period from a third time point before the second beat timing to a fourth time point after the second beat timing.

14. The method according to claim 13, wherein
the light having the third display form in which the light has a third width expands to the light having the first display form in which the light has a larger width during a period from the first time point to the first beat timing, and the light having the first display form contracts to the light having the third display form during a period from the first beat timing to the second time point, and
the light having the third display form expands to the light having the second display form in which the light has a width larger than that of the light having the third display form and smaller than that of the light having the first display form during a period from the third time point to the second beat timing, and the light having the third display form contracts to the light having the second display form during a period from the second beat timing to the fourth time point.

15. A non-transitory recording medium that stores a program for causing a computer that controls a light source unit to execute:
setting one tempo from among a plurality of tempos; and
changing a display form of light emitted from the light source unit and projected on a display section from a third display form to a first display form according to a first beat timing of the set tempo, wherein
a first period in which the light is projected while being changed between the third display form and the first display form has a constant length regardless of the set tempo, and
the constant length is a length of less than one beat of a fastest tempo among settable tempos.

16. The recording medium according to claim 15, wherein
the display form of the light is changed from the third display form to a second display form according to a second beat timing of the set tempo, and
a second period in which the light is projected while being changed between the third display form and the second display form has the constant length regardless of the set tempo.

17. The recording medium according to claim 16, wherein the computer is caused to further execute:
changing the display form of the light to the first display form expressing a strong beat at the first beat timing during the first period; and
changing the display form of the light to the second display form expressing a weak beat at the second beat timing during the second period, wherein
the light having the first display form is light having a first width, and
the light having the second display form is light having a second width smaller than the first width.

18. The recording medium according to claim 17, wherein the computer is caused to further execute: causing the light having the third display form in which the light has a third width smaller than the first width and the second width to be projected on the display section during a third period other than the first and second periods.

19. The recording medium according to claim 16, wherein
the first period is a period from a first time point before the first beat timing to a second time point after the first beat timing, and
the second period is a period from a third time point before the second beat timing to a fourth time point after the second beat timing.

20. The recording medium according to claim 19, wherein
the light having the third display form in which the light has a third width expands to the light having the first display form in which the light has a larger width during a period from the first time point to the first beat timing, and the light having the first display form contracts to the light having the third display form during a period from the first beat timing to the second time point, and
the light having the third display form expands to the light having the second display form in which the light has a width larger than that of the light having the third display form and smaller than that of the light having the first display form during a period from the third time point to the second beat timing, and the light having the third display form contracts to the light having the second display form during a period from the second beat timing to the fourth time point.
